(19) United States
(12) Patent Application Publication
(10) Pub. No.: US 2024/0158229 A1
(43) Pub. Date: May 16, 2024

(54) Manufacturing Method and Manufacturing Apparatus of Syngas, and Manufacturing Method of Liquid Hydrocarbon Using the Same

(71) Applicant: SK Innovation Co., Ltd., Seoul (KR)

(72) Inventors: Hee Jung Jeon, Daejeon (KR); Ok Youn Kim, Daejeon (KR); Dong Min Yun, Daejeon (KR)

(21) Appl. No.: 18/374,020

(22) Filed: Sep. 28, 2023

(30) Foreign Application Priority Data
Nov. 15, 2022 (KR) 10-2022-0152538

(51) Int. Cl. C01B 3/40; C01B 3/24; C01B 3/50; C01B 32/40; C01B 32/50

(52) U.S. Cl. CPC C01B 3/40; C01B 3/24; C01B 3/50; C01B 32/40; C01B 32/50; C01B 2203/0238; C01B 2203/1082; C01B 2203/1235; C01B 2203/168

(57) ABSTRACT

Provided is a method for manufacturing syngas including (S1) heat-treating organic wastes under hydrogen and a catalyst in a first reactor; (S2) separating the catalyst and the hydrogen from a product of (S1) and recovering a first mixed gas from which the catalyst and the hydrogen have been removed; (S3) reforming the first mixed gas recovered in (S2) with water vapor to form a product; (S4) separating carbon dioxide from a product of (S3) and recovering a second mixed gas from which the carbon dioxide has been removed; (S5) converting the carbon dioxide separated in (S4) into carbon monoxide through a reverse Boudouard reaction in the second reactor; and (S6) mixing the hydrogen separated in (S2), the mixed gas recovered in (S4), and the carbon monoxide converted in (S5) to produce syngas.

### CROSS-REFERENCE TO RELATED APPLICATION

This application claims priority to Korean Patent Application No. 10-2022-0152538, filed Nov. 15, 2022, the disclosure of which is hereby incorporated by reference in its entirety.

### BACKGROUND OF THE INVENTION

### Field of the Invention

The present disclosure relates to a method and an apparatus for manufacturing syngas, and in some embodiments, to a method and an apparatus for manufacturing syngas which may increase a manufacturing yield of syngas and minimize carbon dioxide emission. In some embodiments, the present disclosure relates to a method for manufacturing a liquid hydrocarbon from syngas manufactured by the method and/or the apparatus disclosed herein.

### Description of Related Art

Organic wastes may seriously damage the environment by decay when landfilled, and should be discarded through a prescribed treatment process after collecting by their properties when discarded. However, since simple disposal of the organic wastes requires securing treatment facilities and consuming a large amount of manpower and is more wasteful than productive, methods and technologies for recycling organic wastes have been developed in recent years. Representatively, a gasification process technology in which syngas is produced using organic wastes and converted into a high value-added product for energization, may be mentioned.

The gasification process generally refers to a series of processes of reacting carbonaceous raw materials such as coal, organic wastes, and/or biomass under the supply of water vapor, oxygen, carbon dioxide, or a mixture thereof to convert the raw materials into syngas formed of hydrogen and carbon monoxide as the main components, in which the “syngas” or “synthesis gas” refers to mixed gas which is usually produced by a gasification reaction and contains hydrogen and carbon monoxide as the main component and may further include carbon dioxide and/or methane.

The gasification process technology has expanded to a technology of producing fuels and raw materials of various compounds, and for example, the syngas may be used as the raw material of a Fischer-Tropsch synthesis reaction to manufacture high value-added products such as light oil, heavy oil, diesel oil, jet oil, and/or lube oil. Besides, it is known that hydrogen in the syngas which is the main product of the gasification process is used to be applied to hydrogen power generation, ammonia manufacture, an oil refining process, and/or the like, and methanol manufactured from the syngas may be used to obtain high value-added chemicals such as acetic acid, olefin, dimethylether, aldehyde, fuel, and/or an additive.

Recently, as a process for manufacturing syngas, a gasification process using a catalyst has been carried out, but due to the formation of coke and the like in the gasification process, the catalyst is inactivated which causes process trouble in continuous operation. In addition, for securing economic feasibility, relatively expensive catalysts need to be recovered, but in order to recover catalyst discharged in the state in which coke is agglomerated, a plurality of subsequent processes (such as hot-water extraction and lime digestion) should be carried out, and thus, process efficiency is significantly deteriorated.

Since the conventionally performed gasification process of organic wastes has a significantly low manufacturing yield of syngas which may be converted into a high value-added product of 30% or less and has poor productivity, commercialization using the process is limited. Further, in terms of environmental protection, it is preferred to suppress CO₂ emission, but since the gasification reaction product of organic wastes contains CO₂ in addition to H₂ and CO, carbon dioxide emission is higher than that in landfill or pyrolysis treatment, and thus, the gasification process has a serious problem of rather causing more environmental pollution.

Thus, a method and an apparatus for manufacturing syngas which increases a manufacturing yield of syngas which may be converted into a high value-added product and minimize carbon dioxide formation in the gasification process of organic wastes and a manufacturing apparatus of syngas are needed.

### SUMMARY OF THE INVENTION

In some embodiments, the present disclosure is directed to providing a method and an apparatus for manufacturing syngas which have a significantly improved manufacturing yield of syngas from organic wastes.

In some embodiments, the present disclosure is directed to providing a method and an apparatus for manufacturing syngas which may minimize carbon dioxide formation.

In addition, the technical objects to be achieved in the present disclosure are not limited to the above-mentioned technical objects, and other objects which are not mentioned may be clearly understood by those skilled in the art to which the present invention pertains from the following description.

In some embodiments, a method of manufacturing syngas comprises: (S1) heat-treating organic wastes under hydrogen in a first reactor; (S2) separating the hydrogen from a product of (S1) and recovering a first mixed gas from which the hydrogen has been removed; (S3) reforming the first mixed gas recovered in (S2) with water vapor under a catalyst in a second reactor to form a product; (S4) separating the catalyst and carbon dioxide from the product of (S3) and recovering a second mixed gas from which the carbon dioxide has been removed; (S5) converting the carbon dioxide separated in (S4) into carbon monoxide through a reverse Boudouard reaction in a third reactor; and (S6) mixing the hydrogen separated in (S2), the second mixed gas recovered in (S4), and the carbon monoxide converted in (S5) to produce syngas.

In some embodiments, the product of (S1) may comprise methane, hydrogen, carbon monoxide, and/or carbon dioxide.

In some embodiments, 20 vol % or more of methane may be comprised with respect to the total volume of the product of (S1).

In some embodiments, the first mixed gas of (S2) may comprise methane, carbon monoxide, and/or carbon dioxide. In some embodiments, the product of (S3) may comprise carbon monoxide, hydrogen, and/or carbon dioxide.

In some embodiments, in (S3), the catalyst may comprise or be a composite catalyst in which a metal hydride is supported on zeolite.

In some embodiments, the metal hydride may comprise at least one selected from nickel, vanadium, iron, platinum, palladium, or ruthenium.

In some embodiments, the zeolite may comprise ZSM-5, ZSM-11, USY zeolite, ferrierite, mordenite, MCM-22, SUZ-4, and/or L-type zeolite.

In some embodiments, (S5) may further comprise (S5-1) introducing the catalyst separated in (S4) to the third reactor and regenerating the catalyst through a reverse Boudouard reaction; and (S5-2) recirculating and resupplying the regenerated catalyst to (S3).

In some embodiments, (S1) may be performed at a temperature of 500 to 900° C. and/or a pressure of 300 to 600 kPa.

In some embodiments, (S2) may be performed at a temperature of 5 to 50° C. and/or a pressure of 800 to 1200 kPa.

In some embodiments, the reverse Boudouard reaction of (S5) may be performed at a temperature of 800 to 1000° C. and/or a pressure of 300 to 500 kPa.

In some embodiments, the syngas produced in (S6) may comprise hydrogen and carbon monoxide and a molar ratio between the hydrogen and the carbon monoxide may satisfy 1.8 to 2.2.

In some embodiments, the molar ratio between the hydrogen and the carbon monoxide may be adjusted by controlling the reverse Boudouard reaction depending on a flow rate of the hydrogen separated in (S2), the carbon monoxide produced in (S3), or carbon monoxide converted in (S3).

In some embodiments, the molar ratio between the hydrogen and the carbon monoxide may be adjusted by supplying separate carbon dioxide to (S3) depending on the flow rate of the hydrogen separated in (S2), the carbon monoxide produced in (S3), or carbon monoxide converted in (S3).

In some embodiments, the organic wastes in (S1) may be at least one selected from waste plastic, solid wastes, biomass, waste oil, or waste tires.

In some embodiments, before (S2), the mixed gas produced in (S1) may be further purified.

In some embodiments, an apparatus for manufacturing syngas comprises: a first reactor where organic wastes are introduced and a gasification reaction is performed under hydrogen; a hydrogen separation unit where a product is introduced from the first reactor, the hydrogen is separated, and a first mixed gas from which the hydrogen has been removed is recovered; a second reactor where the first mixed gas from which the hydrogen has been removed is introduced from a hydrogen separation unit and a water vapor reforming reaction is performed under a catalyst to form a product; a carbon dioxide separation unit where the product is introduced from the second reactor, carbon dioxide is separated, and a second mixed gas from which the carbon dioxide has been removed is recovered; a third reactor where the carbon dioxide separated from the carbon dioxide separation unit is introduced and a reverse Boudouard reaction is performed; and a syngas production unit where the hydrogen separated from the hydrogen separation unit, the second mixed gas recovered from the carbon dioxide separation unit, and carbon monoxide converted from the third reactor are mixed to produce syngas.

In some embodiments, the first reactor may comprise a fluidized bed reactor or a fixed bed reactor.

In some embodiments, the second reactor may comprise a fluidized bed reactor.

In some embodiments, the third reactor may comprise a fluidized bed reactor.

In some embodiments, the hydrogen separation unit may comprise a pressure swing adsorption (PSA) device.

In some embodiments, a purification unit may be further comprised between the first reactor and the hydrogen separation unit.

In some embodiments, the manufacturing apparatus of syngas may further comprise a cyclone which separates the catalyst from the product of the second reactor; a supply line which supplies the catalyst separated from the cyclone to the third reactor; and a recirculation line which resupplies the regenerated catalyst from the third reactor to the second reactor.

In some embodiments, a manufacturing method of a liquid hydrocarbon comprises: supplying syngas to a fourth reactor; and performing a Fischer-Tropsch synthesis reaction in the fourth reactor, wherein the syngas is the syngas produced by produced by any of the methods disclosed herein.

In some embodiments, the fourth reactor may comprise a fluidized bed reactor.

In some embodiments, the liquid hydrocarbon may comprise naphtha having a boiling point of 150° C. or lower, kerosene having a boiling point of 150 to 265° C., LGO having a boiling point of 265 to 340° C., and VGO having a boiling point of 340° C. or higher.

Other features and aspects will be apparent from the following detailed description, the drawings, and the claims.

### BRIEF DESCRIPTION OF THE DRAWINGS

FIG. 1 illustrates a block diagram of a method for manufacturing syngas according to some embodiments of the present disclosure comprising a first reactor, a hydrogen separation unit, a second reactor, a carbon dioxide separation unit, a third reactor, and a syngas production unit.

FIG. 2 illustrates a block diagram of a method for manufacturing syngas according to some embodiments of the present disclosure comprising a first reactor, a purification unit, a hydrogen separation unit, a second reactor, a carbon dioxide separation unit, a third reactor, and a syngas production unit.

FIG. 3 illustrates a block diagram of a method for manufacturing syngas according to some embodiments of the present disclosure comprising a first reactor, a purification unit, a hydrogen separation unit, a second reactor, a cyclone, a carbon dioxide separation unit, a third reactor, and a syngas production unit.

FIG. 4 illustrates a block diagram of a method for manufacturing syngas according to some embodiments of the present disclosure comprising a first reactor, a hydrogen separation unit, a second reactor, a carbon dioxide separation unit, a third reactor, a syngas production unit, and a fourth reactor.

### DETAILED DESCRIPTION OF MAIN ELEMENTS

1: feed, 100: first reactor, 200: hydrogen separation unit, 300: second reactor, 400: carbon dioxide separation unit, 500: third reactor, 600: syngas production unit, 700: purification unit, 800: cyclone, 900: Fourth reactor

### DESCRIPTION OF THE INVENTION

The singular form used in the present specification and claims appended thereto may be intended to include a plural form also, unless otherwise indicated in the context. As used herein, the singular form of “a”, “an”, and “the” include plural referents unless the context clearly states otherwise.

The numerical range used in the present specification includes all values within the range including the lower limit and the upper limit, increments logically derived in a form and spanning in a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

In the present disclosure, the terms such as “comprise”, “include”, “contain”, “have”, and “may be” mean that there is a characteristic or a constitutional element described in the specification, and as long as it is not particularly limited, a possibility of adding one or more other characteristics or constitutional elements is not excluded in advance.

The unit of ppm used without particular mention in the present specification refers to ppm by mass, unless otherwise defined.

A boiling point used without particular mention in the present specification refers to a boiling point at 25° C. under 1 atm.

A density used without particular mention in the present specification refers to a density at 25° C. under 1 atm.

“Gasification” which is used without particular mention in the present specification refers to a thermal-chemical conversion process through a chemical structure change of a carbonaceous material in the presence of a gasifier (air, oxygen, steam, carbon dioxide, or a mixture thereof) in a broad sense, and refers to a process of converting the carbonaceous material mainly into syngas in a narrower sense.

As a conventional process for manufacturing syngas, a gasification process using a catalyst is carried out, but due to the formation of coke and the like in the gasification process, the catalyst is inactivated which causes process trouble in continuous operation. In addition, for securing economic feasibility, relatively expensive catalysts need to be recovered, but in order to recover catalyst discharged in the state in which coke is agglomerated, a plurality of subsequent processes (such as hot-water extraction and lime digestion) should be carried out, and thus, process efficiency is significantly deteriorated.

Since the conventionally performed gasification process of organic wastes has a significantly low manufacturing yield of syngas which may be converted into a high value-added product of 30% or less and has poor productivity, commercialization using the process is limited. Further, in terms of environmental protection, it is preferred to suppress CO₂ emission, but since the gasification reaction product of organic wastes contains CO₂ in addition to H₂ and CO, carbon dioxide emission is higher than that in landfill or pyrolysis treatment, and thus, the gasification process has a serious problem of rather causing more environmental pollution.

Thus, the present disclosure provides a method of manufacturing syngas comprising: (S1) heat-treating organic wastes under hydrogen in a first reactor; (S2) separating the hydrogen from a product of (S1) and recovering a first mixed gas from which the hydrogen has been removed; (S3) reforming the first mixed gas recovered in (S2) with water vapor under a catalyst in a second reactor to form a product; (S4) separating the catalyst and carbon dioxide from the product of (S3) and recovering a second mixed gas from which the carbon dioxide has been removed; (S5) converting the carbon dioxide separated in (S4) into carbon monoxide through a reverse Boudouard reaction in a third reactor; and (S6) mixing the hydrogen separated in (S2), the second mixed gas recovered in (S4), and the carbon monoxide converted in (S5) to produce syngas. The manufacturing method of syngas comprising a series of processes of (S1) to (S6) may minimize carbon dioxide formation as compared with that of a conventional gasification process to prevent environmental pollution and also significantly improve a manufacturing yield of syngas from organic wastes.

In (S1), organic wastes are heat-treated under hydrogen in the first reactor, and a gasification reaction of the organic wastes may occur. In some embodiments, in (S1), at least one gasification reaction selected from the following Reaction Formulae 1 to 4 may be involved:

[Reaction Formula 1]

C+H₂O→H₂+CO (aqueous gasification reaction of carbon)

[Reaction Formula 2]

C+CO₂→2CO (carbon dioxide gasification reaction of carbon)

[Reaction Formula 3]

CO+3H₂→CH₄+H₂O (methanation reaction)

[Reaction Formula 4]

C+O₂→CO₂ (oxidation reaction of carbon).

In some embodiments, the product of (S1) may comprise methane, hydrogen, carbon monoxide, and/or carbon dioxide. Usually, when performing a heat treatment process of organic wastes, the product may comprise methane, hydrogen, carbon monoxide, and/or carbon dioxide, and in addition to that, various impurities such as water vapor, nitrogen oxides, sulfur oxides, and/or hydrogen chloride may be present. In the present disclosure, the organic wastes are heat-treated under hydrogen, thereby obtaining a product having a higher methane content than that of the gasification process of the organic wastes which are conventionally usually performed. As described above, in (S1), since the product having a high methane content is obtained, the efficiency of the method of manufacturing syngas comprising a series of processes (S1) to (S6) may be optimized and the manufacturing yield of syngas may be maximized. Herein, in some embodiments the first reactor may comprise a fluidized bed reactor or a fixed bed reactor.

In some embodiments, 20 vol % or more of methane may be comprised with respect to the total volume of the product of (S1). By performing a heat treatment of organic wastes under hydrogen, 20 vol % or more of methane with respect to the total volume of the product may be comprised, and as described later, when the heat treatment is performed under high pressure hydrogen conditions, a methane content may be further improved. In some embodiments, methane may be comprised at 40 vol % or more, or 60 vol % or more with respect to the total volume of the product. In some embodiments, methane may be comprised at 99 vol % or less without limitation.

(S1) may be performed under the catalyst conditions. (S1) is performing a heat treatment of organic wastes under hydrogen, and in some embodiments it may be favorable that a catalyst for hydrogen activation is used as the catalyst in terms of reaction activity. In some embodiments, the catalyst may comprise active metal having hydrotreating catalytic ability, or may be active metal supported on a support. Any active metal may be used as long as it has required catalytic ability, and for example, may comprise any one or more selected from molybdenum, cobalt, nickel, and/or the like. Any support may be used as long as it has durability to support the active metal, and for example, may comprise at least one selected from silicon, aluminum, sodium, titanium, and/or the like, and/or oxides of thereof; and/or at least one carbon-based material selected from carbon black, active carbon, graphene, carbon nanotubes, graphite, and/or the like. Without being necessarily limited to the catalyst conditions, in some embodiments the step may be performed under non-catalytic conditions. When it is performed under non-catalytic conditions, it may be favorable to perform the step at a higher temperature for improving reaction activity.

(S2) is recovering a first mixed gas, in which hydrogen is separated from the product of (S1) and the first mixed gas from which hydrogen has been removed may be recovered. The efficiency of steam reforming reaction may be improved by separating hydrogen. A method for separating hydrogen may use a conventionally known method, and for example, hydrogen may be separated using a pressure swing adsorption device.

In some embodiments, the first mixed gas of (S2) comprises methane, carbon monoxide, and/or carbon dioxide, and the product of (S3) may comprise carbon monoxide, hydrogen, and/or carbon dioxide.

(S3) is a step of reforming the first mixed gas recovered in (S2) with water vapor (steam reforming reaction) in the presence of a catalyst in the second reactor, and in some embodiments, a reaction like Reaction Formula 5 may be involved:

[Reaction Formula 5]

CH₄+H₂O→CO+3H₂ (steam modification reaction of methane).

Since methane comprised in the first mixed gas is converted into hydrogen and carbon monoxide, the contents of hydrogen and carbon monoxide which are the main components of syngas may be significantly improved. Since hydrogen is pre-separated in (S2), and (S3) is performed on the first mixed gas from which hydrogen has been removed, the activity of the steam reforming reaction of methane may be increased and a manufacturing yield of syngas may be maximized. (S3) may be performed at a temperature of 500 to 900° C. and/or a pressure of 100 to 300 kPa under water vapor conditions. Within the range, the efficiency of the reforming reaction may be excellent. In some embodiments, the temperature may be 550 to 850° C. and/or the pressure may be 100 to 250 kPa, or the temperature may be 600 to 850° C. and/or the pressure may be 150 to 250 kPa. It is preferred that (S3) is performed under a catalyst for improving reaction efficiency. The detailed description for the catalyst will be provided later, and in some embodiments the second reactor may comprise a fluidized bed reactor. In terms of the efficiency of the steam reforming reaction and a catalyst regeneration process described later, it is preferred to use a fluidized bed reactor, in which the fluidized bed reactor may be a riser.

When performing the heat treatment process of organic wastes in (S1), a product having a high methane content is obtained and (S2) and (S3) are performed on the product, thereby solving the conventional problem of a significantly low manufacturing yield of syngas. In addition, as described later, by a series of processes of manufacturing syngas comprising (S1) to (S6), carbon dioxide emission may be minimized to prevent environmental pollution and simultaneously maximize the manufacturing yield of syngas.

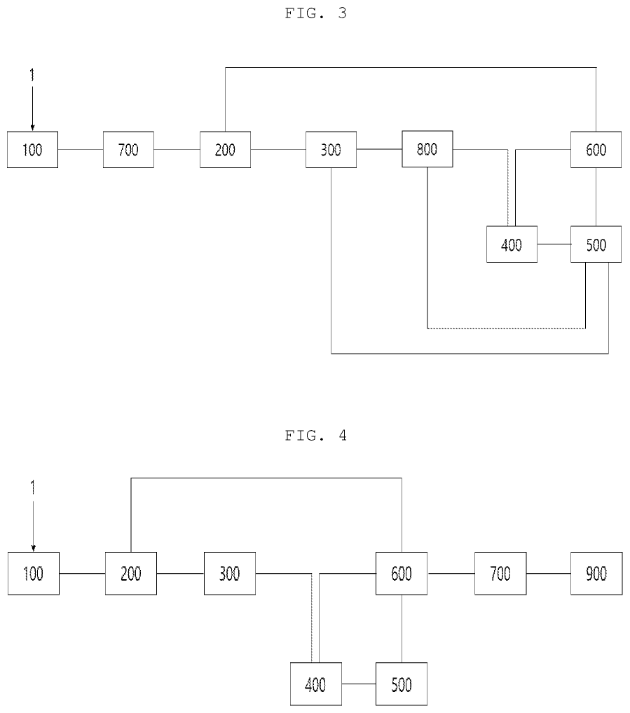

(S4) is a step of recovering the second mixed gas, in which the catalyst and carbon dioxide are separated from the product of (S3) and the second mixed gas from which carbon dioxide has been removed may be recovered. In the separation of the catalyst and carbon dioxide (CO₂), it is preferred to separate the catalyst first and then separate carbon dioxide (CO₂), but the present disclosure is not necessarily limited thereto, and the catalyst and carbon dioxide (CO₂) may be separated at the same time. Referring to FIG. 3, as described later, it is preferred that a cyclone is provided between the second reactor and a carbon dioxide separation unit to separate the catalyst from the product of the second reactor (first mixed gas), and then the product from which the catalyst has been separated is introduced to the carbon dioxide separation unit to separate carbon dioxide and recover the second mixed gas.

(S5) is a step of converting carbon dioxide separated in (S4) into carbon monoxide through a reverse Boudouard reaction in the third reactor, in which carbon dioxide produced by the heat treatment process of (S1) is not emitted to the outside, but converted into carbon monoxide, thereby preventing environmental pollution and simultaneously improving a manufacturing yield of syngas. The reverse Boudouard reaction may involve the reaction of the following Reaction Formula 6. In order to perform the reverse Boudouard reaction well, carbon such as activated carbon may be supplied, or as described later, in (S1), a catalyst inactivated by coke and/or the like is used to perform the reverse Boudouard reaction.

[Reaction Formula 6]

C+CO₂→2CO (reverse Boudouard reaction)

Carbon monoxide which has been converted by the reverse Boudouard reaction of (S5) may be used in the production of syngas in (S6) described later. When unreacted carbon dioxide is present in the product of (S5), carbon dioxide is separated again from the product, and the reverse Boudouard reaction of (S5) may be repeated once or more on the separated carbon dioxide. Accordingly, carbon dioxide may be converted into carbon monoxide in a very high yield.

(S6) is a step of producing syngas, in which the hydrogen separated in (S2), the second mixed gas recovered in (S4), and carbon monoxide converted in (S5) may be mixed to produce syngas. As described above, syngas refers to a mixed gas comprising hydrogen and carbon dioxide as main components, and the syngas may be used as a raw material of a Fischer-Tropsch reaction to manufacture high value-added products. Herein, in some embodiments it is preferred that a stoichiometrically required molar ratio of H₂:CO is about 2:1, although this ratio is not required.

In the present disclosure, the manufacturing yield of syngas in the method of manufacturing syngas comprising a series of steps of (S1) to (S6) may be maximized, and carbon dioxide emission may be minimized to prevent environmental pollution.

In some embodiments, (S5) may further comprise (S5-1) introducing the catalyst separated in (S4) to the third reactor and regenerating the catalyst through a reverse Boudouard reaction; and (S5-2) recirculating and resupplying the regenerated catalyst to (S3). In a conventional gasification process, the catalyst is inactivated by occurrence of by-products such as coke, so that process trouble occurs by the inactivated catalyst during continuous operation. In order to solve the problem, a certain amount of a new catalyst is continuously exchanged with a waste catalyst to maintain a catalytic activity at a certain level or higher, but process efficiency is significantly deteriorated in the exchange process. In the present disclosure, carbon dioxide is converted into carbon monoxide in the reverse Boudouard reaction, a waste catalyst in which coke and the like are agglomerated is simultaneously treated together to regenerate the catalyst, and the catalyst is recirculated and resupplied to the second reactor of (S3), thereby significantly improving process efficiency. When the catalyst circulation process as such is included, the third reactor may comprise a fluidized bed reactor, and for example, a regenerator in the fluidized bed reactor.

In some embodiments, in (S3), the catalyst may be a composite catalyst in which a metal hydride is supported on zeolite. The metal hydride may comprise at least one selected from nickel, vanadium, iron, platinum, palladium, or ruthenium. As the metal hydride, commonly known metals such as nickel, vanadium, or iron may be used, and when the raw material such as an organic waste has a low impurity content in the heat treatment process, a precious metal may be used. The precious metal may be platinum, palladium, or ruthenium.

The zeolite may comprise ZSM-5, ZSM-11, USY zeolite, ferrierite, mordenite, MCM-22, SUZ-4, and/or L-type zeolite. The zeolite may be any zeolite having durability to support active metal, and in some embodiments, may be ZSM-5 or USY zeolite in terms of improving heat treatment efficiency and gasification efficiency.

Separation of carbon dioxide in (S4) may be performed using various carbon dioxide separation units. In some embodiments, it may be performed using an amine scrubber. Usually, the amine scrubber binds to and removes carbon dioxide by an amine-based material, and it may separate components such as carbon dioxide and hydrogen sulfide from gas steam and recover steam containing hydrogen, carbon monoxide or inert gas. In some embodiments, the product is added from the second reactor to an amine solution at a temperature of 40 to 100° C. with a first amine scrubber to capture carbon dioxide, and is heated to 100 to 200° C. in a second amine scrubber to separate amine and carbon dioxide. When the amine scrubber is used, carbon dioxide may be separated at a lower temperature as compared with a CCS unit described later, and thus, it may be favorable in terms of process stability.

In some embodiments, separation of carbon dioxide may be performed using a carbon capture and storage (CCS) unit. The CCS unit may adsorb and separate carbon dioxide using an adsorbent comprising at least one selected from calcium oxide, calcium hydroxide, dolomite, limestone, or trona. In some embodiments, the adsorbent may be calcium oxide. The adsorption of carbon dioxide (CO₂) in the CCS unit may be performed at a temperature of 500° C. or higher and lower than 800° C. and/or a pressure of 30 to 500 kPa. Under the conditions, carbon dioxide adsorption efficiency may be excellent. In some embodiments, the temperature may be 500 to 700° C. and/or the pressure may be 50 to 150 kPa, or the temperature may be 550 to 650° C. and/or the pressure may be 50 to 100 kPa. Carbon dioxide adsorbed by the adsorbent in the CCS unit is desorbed again and the desorption may be performed at a temperature of higher than 500° C. and 1000° C. or lower and/or a pressure of 30 to 500 kPa. Under the conditions, carbon dioxide desorption efficiency may be excellent. In some embodiments, the temperature may be 700 to 950° C. and/or the pressure may be 50 to 150 kPa, or the temperature may be 850 to 950° C. and/or the pressure may be 50 to 100 kPa.

In some embodiments, (S1) may be performed at a temperature of 500 to 900° C. and/or a pressure of 300 to 600 kPa. Under the conditions, heat treatment efficiency may be excellent, and in some embodiments, the heat treatment is performed under high pressure hydrogen conditions of 300 to 500 kPa, thereby improving a methane content in the product. In some embodiments, the temperature may be 600 to 850° C. and/or the pressure may be 350 to 500 kPa, or the temperature may be 700 to 850° C. and/or the pressure may be 400 to 500 kPa.

In some embodiments, (S2) may be performed at a temperature of 5 to 50° C. and/or a pressure of 800 to 1200 kPa. Under the conditions, the catalyst and hydrogen may be effectively separated from the product of (S1). In some embodiments, the temperature may be 10 to 50° C. and/or the pressure may be 1000 to 1100 kPa, or the temperature may be 20 to 50° C. and/or the pressure may be 1000 to 1050 kPa.

In some embodiments, the reverse Boudouard reaction of (S5) may be performed at a temperature of 800 to 1000° C. and/or a pressure of 30 to 500 kPa. Under the conditions, the conversion efficiency from carbon dioxide into carbon monoxide and the catalyst regeneration efficiency may be excellent. In some embodiments, the temperature may be 800 to 950° C. and the pressure may be 50 to 150 kPa, or the temperature may be 800 to 900° C. and/or the pressure may be 50 to 100 kPa.

In some embodiments, the syngas produced in (S6) may comprise hydrogen (H₂) and carbon monoxide (CO) and a molar ratio between hydrogen (H₂) and carbon monoxide (CO) may satisfy 1.8 to 2.2. As described above, the syngas is used as a raw material of the Fischer-Tropsch reaction and converted into high value-added products such as light oil, heavy oil, diesel oil, jet oil, and lube oil, and when a stoichiometrically required molar ratio of H₂:CO satisfies 1.8 to 2.2, conversion efficiency may be excellent. Preferably, the molar ratio of H₂:CO may be 1.9 to 2.1, or 1.95 to 2.05.

In some embodiments, the molar ratio between the hydrogen and the carbon monoxide may be adjusted by controlling the reverse Boudouard reaction depending on a flow rate of the hydrogen separated in (S2), the carbon monoxide produced in (S3), or carbon monoxide converted in (S5). A flow rate of the hydrogen separated in (S2) or the carbon monoxide converted in (S3) is measured in real time and the reverse Boudouard reaction is controlled so that the molar ratio of H₂:CO is satisfied. Flow rates of H₂ and CO in the mixed gas recovered in (S2) also may be measured and the reaction conditions and the reaction speed of the reverse Boudouard reaction are adjusted to satisfy the molar ratio of H₂:CO.

In some embodiments, the molar ratio between the hydrogen and the carbon monoxide may be adjusted by supplying separate carbon dioxide to (S5) depending on the flow rate of the hydrogen separated in (S2), the carbon monoxide produced in (S3), or carbon monoxide converted in (S5). When CO is significantly small in the molar ratio of H₂:CO, carbon dioxide is separately supplied to (S5), thereby improving the reverse Boudouard reaction activity to satisfy the molar ratio of H₂:CO. The supply of carbon dioxide may be performed by a separate carbon dioxide storage unit. When a H₂ content is low as compared with CO and it is difficult to adjust the molar ratio of H₂:CO to 2, a water gas shift (WGS) reaction may be further performed.

In some embodiments, the organic wastes in (S1) may be at least one selected from waste plastic, solid wastes, biomass, waste oil, and/or waste tires. Without being necessarily limited thereto, any carbon-containing material such as biomass and/or coal may be used without limitation as the raw material of a gasification reaction, but considering the problem to be solved in the present disclosure, it may be appropriate to use the organic wastes.

In some embodiments, before (S2), the mixed gas produced in (S1) may be further purified. The mixed gas produced in (S1) may further comprise other components such as impurity gas(es) such as water vapor, H₂S, HCl, HOCl, and/or NH₃, and/or fine dust, in addition to hydrogen (H₂), carbon monoxide (CO), and carbon dioxide (CO₂). By removing other components such as water vapor through the step of purifying the mixed gas, a manufacturing yield of syngas may be further improved. Before (S2), when H₂ is relatively insufficiently produced in the gasification process depending on the kind of organic wastes, a water gas shift (WGS) reaction may be performed to replenish H₂, thereby improving the manufacturing yield of syngas. The WGS reaction may be performed in the conditions of 20 to 70 bar and/or 100 to 250° C. under a catalyst. The catalyst may be used without limitation as long as it is a catalyst having WGS reaction activity, and preferably, may be a Cu—Zn mixed catalyst. Herein, since carbon dioxide produced by the water gas shift reaction is converted into carbon monoxide by the reverse Boudouard reaction, the environmental pollution problem caused by performing the conventional water gas shift reaction may be solved and simultaneously the effect of improving a manufacturing yield of syngas may be promoted.

In addition, the present disclosure provides an apparatus for manufacturing syngas comprising: a first reactor where organic wastes are introduced and a gasification reaction is performed under hydrogen to produce a product; a hydrogen separation unit where the product is introduced from the first reactor, the hydrogen is separated, and a first mixed gas from which the hydrogen has been removed is recovered; a second reactor where the first mixed gas from which the hydrogen has been removed is introduced from a hydrogen separation unit and a reforming reaction is performed with water vapor under a catalyst; a carbon dioxide separation unit where a product is introduced from the second reactor, carbon dioxide is separated, and a second mixed gas from which the carbon dioxide has been removed is recovered; a third reactor where the carbon dioxide separated from the carbon dioxide separation unit is introduced and a reverse Boudouard reaction is performed; and a syngas production unit where the hydrogen separated from the hydrogen separation unit, the second mixed gas from which carbon dioxide has been removed in the carbon dioxide separation unit, and carbon monoxide converted from the third reactor are mixed to produce syngas. The syngas may be manufactured in a high yield from the organic wastes by the apparatus, and carbon dioxide emission is minimized to prevent environmental pollution.

In some embodiments, the first reactor may comprise a fluidized bed reactor or a fixed bed reactor. The first reactor performs gasification by heat-treating organic wastes, and may use the fluidized bed reactor or the fixed bed reactor without limitation. As described later, considering the use of the fluidized bed reactor as the second reactor and the third reactor, it is preferred to use the fluidized bed reactor in terms of process efficiency. The fluidized bed reactor may cause a gasification reaction by fluidizing and mixing in a state in which a solid layer (layer material) is suspended by reaction gas having an upward flow.

In some embodiments, the second reactor may comprise a fluidized bed reactor.

In some embodiments, the third reactor may comprise a fluidized bed reactor.

In some embodiments, it is preferred to use the fluidized bed reactor as the second reactor and the third reactor in terms of a catalyst regeneration process. Herein, in some embodiments, the second reactor may be a riser in the fluidized bed reactor, and the third reactor may be a regenerator in the fluidized bed reactor.

In some embodiments, the hydrogen separation unit may comprise a pressure swing adsorption (PSA) device. Commonly known various devices may be used as a hydrogen separation unit, but it is preferred to use the pressure swing adsorption device.

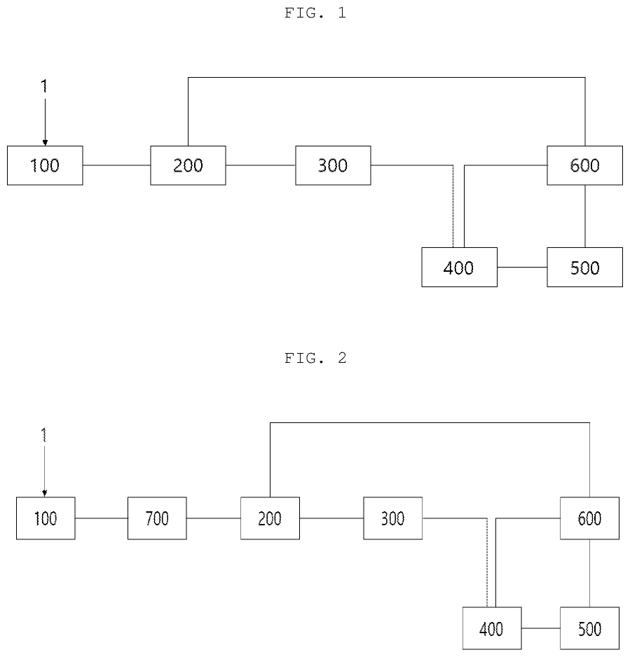

As shown in FIG. 1, an organic waste 1 is introduced into a first reactor and heat-treated under hydrogen to perform a gasification reaction. The product produced in the first reactor 100 may comprise methane, hydrogen, carbon monoxide, and carbon dioxide. The product is introduced from the first reactor 100 to the hydrogen separation unit to separate hydrogen and recover the first mixed gas from which hydrogen has been removed. The first mixed gas from which hydrogen has been removed is introduced to the second reactor and a water vapor reforming reaction may be performed under a catalyst. The product of the second reactor may be introduced to the carbon dioxide separation unit to separate carbon dioxide and recover the second mixed gas from which carbon dioxide has been removed. The separated carbon dioxide may be introduced from the carbon dioxide separation unit and converted into carbon monoxide by the reverse Boudouard reaction. Hydrogen separated from the hydrogen separation unit, the second mixed gas recovered from the carbon dioxide separation unit, and carbon monoxide converted in the third reactor may be mixed in the syngas production unit to produce syngas. Herein, when unreacted carbon dioxide remains in the product of the third reactor, the product may be introduced again to the carbon dioxide separation unit to separate carbon dioxide from the product, and the separated carbon dioxide may be introduced again to the third reactor to perform the reverse Boudouard reaction again. The process may be repeated once or more, thereby converting unreacted carbon dioxide into carbon monoxide to increase a carbon monoxide conversion rate.

In some embodiments, a purification unit 700 may be further comprised between the first reactor and the hydrogen separation unit, as shown in FIG. 2. In the purification unit 700, the purification may be performed by a dust collection filter for high temperature/high pressure or a wet scrubber, and aqueous impurity gas components such as H₂S, HCl, HOCl, and/or NH₃ are removed to further improve the manufacturing yield of syngas.

In some embodiments, the apparatus for manufacturing syngas may further comprise a cyclone 800 which separates the catalyst from the product of the second reactor 300; a supply line which supplies the catalyst separated from the cyclone 800 to the third reactor 500; and a recirculation line which resupplies the regenerated catalyst from the third reactor 500 to the second reactor 300, as shown in FIG. 3. The catalyst separated from the cyclone 800 is introduced to the third reactor 500, in which the catalyst may comprise a coke component produced in a pyrolysis process of organic wastes. Carbon dioxide may be introduced from the carbon dioxide separation unit 400 to the third reactor 500. Besides, a separate carbon dioxide storage unit may be provided to introduce separate carbon dioxide. The catalyst is treated with carbon dioxide at a high temperature of 800° C. or higher, thereby removing impurities such as coke comprised in the catalyst. The catalyst may be reintroduced to the second reactor 300 through the recirculation line.

For the matters which are not described in the apparatus of manufacturing syngas, the above description of the method of manufacturing syngas may be referred.

In some embodiments, the present disclosure provides a manufacturing method of a liquid hydrocarbon comprising: supplying syngas to a fourth reactor; and performing a Fischer-Tropsch synthesis reaction in the fourth reactor, wherein the syngas is the syngas produced by any of the methods disclosed herein. The syngas produced through (S1) to (S6) is used as the raw material of the Fischer-Tropsch synthesis reaction represented by the following Reaction Formula 7, thereby manufacturing a liquid hydrocarbon:

[Reaction Formula 7]

nCO+2nH₂→CnH₂ₙ+nH₂O.

FIG. 4 illustrates a block diagram of the manufacturing method of a liquid hydrocarbon. The fourth reactor 900 may be a Fischer-Tropsch synthesis reactor, in which the reactor 900 may comprise a liquid product separation and heavy end recovery unit. In order to improve a manufacturing yield of the liquid hydrocarbon, it is preferred that a stoichiometrical molar ratio of H₂:CO satisfies 1.8 to 2.2. In some embodiments, the molar ratio of H₂:CO may be 1.9 to 2.1, or 1.95 to 2.05. The liquid hydrocarbon may comprise naphtha having a boiling point of 150° C. or lower, kerosene having a boiling point of 150 to 265° C., LGO having a boiling point of 265 to 340° C., and/or VGO having a boiling point of 340° C. or higher. The syngas produced in the conventional gasification process of organic wastes has a low amount of syngas (H₂, CO) which may be converted into a product (liquid hydrocarbon) and a lower molar mass of H₂ compared to CO in H₂:CO, and thus, a recovery rate of the expected product is significantly deteriorated. The syngas produced by the steps of (S1) to (S6) of the present disclosure is used as the raw material of the Fischer-Tropsch synthesis reaction, thereby improving the recovery rate of the liquid hydrocarbon product as compared with the conventional gasification process of organic wastes. In order to obtain high-quality liquid hydrocarbon, it is preferred that a purification unit is provided in the front of the Fischer-Tropsch synthesis reactor and the purification process is performed.

Hereinafter, the present disclosure will be described in detail by the examples, however, the examples are for describing the present disclosure more detail, and the scope of rights is not limited to the following examples.

### Example 1

A manufacturing apparatus of syngas comprising a first reactor (fluidized bed reactor), a purification unit (wet scrubber), a hydrogen separation unit (pressure swing adsorption device, PSA), a second reactor (fluidized bed reactor), a carbon dioxide separation unit, a third reactor (fluidized bed reactor), and a syngas production unit was operated for 120 minutes to manufacture syngas.

Specifically, 100 g of municipal solid wastes (MSW) was added to the first reactor, and heat-treated at a temperature of 750° C. and a pressure of 300 kPa under a CoMo/r-Al₂O₃ catalyst and a hydrogen gas.

The product was added from the fluidized bed reactor to the purification unit (wet scrubber), treated at 70° C. and 100 kPa to remove impurities, and then introduced to the hydrogen separation unit to separate hydrogen under 25° C. and 1013 kPa, and a first mixed gas from which hydrogen had been removed was recovered.

The first mixed gas from which hydrogen had been separated in the hydrogen separation unit was introduced to a second reactor equipped with a Ni/USY zeolite catalyst and treated at 750° C. and 250 kPa under water vapor to perform a stream reforming reaction.

The catalyst was separated from the product of the second reactor using a cyclone, and CO₂ was recovered from the product from which the catalyst had been separated using an amine scrubber. A reactant gas was added to an amine solution at 50° C. in a first amine scrubber to capture CO₂, the temperature was raised to 100° C. or higher in a second amine scrubber to separate amine and CO₂, and amine was recovered.

The separated carbon dioxide was added to the third reactor and a reverse Boudouard reaction was performed to convert carbon dioxide into carbon monoxide.

Hydrogen separated from the hydrogen separation unit, the second mixed gas recovered from the carbon dioxide separation unit, and carbon monoxide converted in the third reactor were all introduced to a synthesis unit and mixed at 200° C. to manufacture syngas.

In this process, while the flow rate of hydrogen separated from the hydrogen separation unit and the flow rate of carbon monoxide produced in the second reactor and/or carbon monoxide converted in third reactor were measured in real time, in order to adjust the molar ratio of H₂:CO in the synthesis gas to 2, the reaction activity and/or the reactant composition activity of the hydrogen separation reaction, steam reforming reaction, and inverse Buddha reaction were adjusted. At this time, the reaction activity of the reverse Buda reaction can be performed through a reverse Buda reaction control device.

In addition, the separated catalyst was supplied to the third reactor through a separate supply line, treated with the reverse Boudouard reaction, regenerated, and then resupplied to the second reactor through a recirculation line connected to the second reactor.

### Example 2

Syngas was manufactured in the same manner as in Example 1, except that the reaction was performed at the temperature of the first reactor of 850° C. and the pressure of 450 kPa.

### Example 3

Syngas was manufactured in the same manner as in Example 1, except that the flow rate of hydrogen and corbon monoxide were not measured in real time.

### Example 4

Syngas was manufactured in the same manner as in Example 1, except that the process of regenerating the catalyst separated from the third reactor was not performed.

### Comparative Example 1

Syngas was manufactured in the same manner as in Example 1, except that the hydrogen separation step was not performed by using the manufacturing apparatus of syngas including no hydrogen separation unit.

### Comparative Example 2

Syngas was manufactured in the same manner as in Example 1, except that the steam reforming reaction was not performed by using the manufacturing apparatus of syngas including no second reactor.

### Comparative Example 3

Syngas was manufactured in the same manner as in Example 1, except that the reverse Boudouard reaction was not performed by using the manufacturing apparatus of syngas including no third reactor.

### Comparative Example 4

Syngas was manufactured in the same manner as in Example 1, except that the heat treatment was performed at a temperature of 800° C. and a pressure of 350 kPa under the gas conditions of the first reactor of water vapor, not hydrogen.

### Evaluation Example

The composition of the syngas manufactured by operating the manufacturing apparatus of syngas for 120 minutes was analyzed by gas chromatograph and a total amount of gas was confirmed by a gas meter. Specifically, the syngas was quantified by GC to calculate selectivity for each gas, and the composition of each gas was analyzed by the total amount of gas confirmed from a flowmeter, thereby evaluating the gas manufacturing yield and a carbon dioxide reduction effect.

The evaluation results are shown in the following Table 1:

TABLE 1

| | | Example | Example | Example | Example | Comparative | Comparative | Comparative | Comparative |
|---|---|---|---|---|---|---|---|---|---|
| | | 1 | 2 | 3 | 4 | Example 1 | Example 2 | Example 3 | Example 4 |
| H₂ | Molar rate | 2430 | 2630 | 2285 | 1952 | 1694 | 946 | 1816 | 1670 |
| | (lbmol/hr) | | | | | | | | |
| | Composition | 66 | 66 | 66 | 64 | 64 | 63 | 59 | 64 |
| | (vol %) | | | | | | | | |
| CO | Molar rate | 1220 | 1315 | 1128 | 983 | 852 | 483 | 549 | 827 |
| | (lbmol/hr) | | | | | | | | |
| | Composition | 33 | 33 | 32 | 32 | 32 | 32 | 17 | 32 |
| | (vol %) | | | | | | | | |
| CO₂ | Molar rate | 0 | 0 | 0 | 0 | 0 | 0 | 637 | 0 |
| | (lbmol/hr) | | | | | | | | |
| | Composition | 0 | 0 | 0 | 0 | 0 | 0 | 21 | 0 |
| | (vol %) | | | | | | | | |
| Others | Molar rate | 42 | 38 | 55 | 121 | 112 | 82 | 88 | 103 |
| | (lbmol/hr) | | | | | | | | |
| | Composition | 1 | 1 | 2 | 4 | 4 | 5 | 3 | 4 |
| | (vol %) | | | | | | | | |

Referring to the results of analyzing the syngas composition of Table 1, it was confirmed that in the manufacturing process of syngas, Examples 1 to 4 had much better production amounts of H₂ and CO, and had minimized production of CO₂ to have a favorable effect in terms of a syngas manufacturing yield and environmental pollution prevention, as compared with Comparative Examples 1 to 4.

In Example 2, as the temperature conditions were changed, H₂ and CO production amounts were best with H₂ being 2630 lbmol/hr and CO being 1315 lbmol/hr, and the molar ratio of H₂:CO satisfied about 2:1.

It was confirmed in Example 3 that since the reaction was performed without measuring the flow rate of carbon monoxide converted in the second reactor in real time, the molar ratio of H₂:CO did not satisfy 2:1 and the production amounts of H₂ and CO were somewhat lower than those of Example 1 with H₂ being 2285 lbmol/hr and CO being 1128 lbmol/hr, but were higher than those of Comparative Examples 1 to 4.

Since in Example 4, the reaction was performed without performing the regeneration process of the separated catalyst and without recirculation of the catalyst, it was confirmed that the production amount of H₂ and CO were somewhat lower than those of Example 1 with H₂ being 1952 lbmol/hr and CO being 983 lbmol/hr as compared with those of Example 1, but were higher than those of Comparative Examples 1 to 4.

Since in Comparative Example 1, the hydrogen separation step was not performed by using the manufacturing apparatus of syngas including no hydrogen separation unit, it was confirmed that the production amounts of H₂ and CO were much lower than those of Example 1 with H₂ being 1694 lbmol/hr and CO being 852 lbmol/h.

Since in Comparative Example 2, the steam reforming reaction was not performed by using the manufacturing apparatus of syngas including no second reactor, it was confirmed that the production amounts of H₂ and CO were much lower than those of Example 1 with H₂ being 946 lbmol/hr and CO being 483 lbmol/h.

Since in Comparative Example 3, the reaction was performed without performing the reverse Boudouard reaction by using the manufacturing apparatus of syngas including no third reactor, it was confirmed that considering that the CO production amount was much lower and the CO₂ production amount was much higher than those of Example 1 with H₂ being 1816 lbmol/hr, CO being 549 lbmol/hr, and CO₂ being 637 lbmol/hr, and thus, it is not preferred in terms of a manufacturing yield of syngas and environmental pollution.

Since in Comparative Example 4, the heat treatment was performed under the gas conditions of the first reactor which were not hydrogen conditions but water vapor conditions to perform the gasification process, the production amounts of H₂ and CO were significantly lower than those of Example 1 with H₂ being 1670 lbmol/hr, CO being 827 lbmol/hr, and CO₂ being 0 lbmol/hr, as compared with those of Example 1.

The method and the apparatus for manufacturing syngas according to the present disclosure may have a significantly improved manufacturing yield of syngas from organic wastes.

The method and the apparatus for manufacturing syngas according to the present disclosure may minimize carbon dioxide formation in a syngas manufacturing process.

The method and the apparatus for manufacturing syngas according to the present disclosure may also induce an effect of regenerating a waste catalyst in a process of converting carbon dioxide into carbon monoxide to improve process efficiency.

Hereinabove, although the present disclosure has been described by specific matters, limited exemplary embodiments, and drawings, they have been provided only for assisting the entire understanding of the present disclosure, and the present disclosure is not limited to the exemplary embodiments, and various modifications and changes may be made by those skilled in the art to which the present disclosure pertains from the description.

Therefore, the spirit of the present invention should not be limited to the above-described exemplary embodiments, and the following claims as well as all modifications equal or equivalent to the claims are intended to fall within the scope and spirit of the invention.

What is claimed is:

1. A method for manufacturing syngas, the method comprising:
(S1) heat-treating organic wastes under hydrogen in a first reactor;
(S2) separating the hydrogen from a product of (S1) and recovering a first mixed gas from which the hydrogen has been removed;
(S3) reforming the first mixed gas recovered in (S2) with water vapor under a catalyst in a second reactor to form a product;
(S4) separating the catalyst and carbon dioxide from the product of (S3) and recovering a second mixed gas from which the carbon dioxide has been removed;
(S5) converting the carbon dioxide separated in (S4) into carbon monoxide through a reverse Boudouard reaction in a third reactor; and
(S6) mixing the hydrogen separated in (S2), the second mixed gas recovered in (S4), and the carbon monoxide converted in (S5) to produce syngas.

2. The method for manufacturing syngas of claim 1, wherein the product of (S1) comprises methane, hydrogen, carbon monoxide, and carbon dioxide.

3. The method for manufacturing syngas of claim 2, wherein a total volume of the product of (S1) comprises 20 vol % or more of methane.

4. The method for manufacturing syngas of claim 1, wherein the first mixed gas of (S2) comprises methane, carbon monoxide, and carbon dioxide, and the product of (S3) comprises hydrogen, carbon monoxide, and carbon dioxide.

5. The method for manufacturing syngas of claim 1, wherein the catalyst in (S3) is a composite catalyst in which a metal hydride is supported on zeolite.

6. The method for manufacturing syngas of claim 1, wherein (S5) further comprises:
(S5-1) introducing the catalyst separated in (S4) to the third reactor and regenerating the catalyst through a reverse Boudouard reaction; and
(S5-2) recirculating and resupplying the regenerated catalyst to (S3).

7. The method for manufacturing syngas of claim 1, wherein the reverse Boudouard reaction of (S5) is performed at a temperature of 800 to 1000° C. and a pressure of 300 to 500 kPa.

8. The method for manufacturing syngas of claim 1, wherein the syngas produced in (S6) comprises hydrogen and carbon monoxide and a molar ratio between the hydrogen and the carbon monoxide satisfies 1.8 to 2.2.

9. The method for manufacturing syngas of claim 8, wherein the molar ratio between the hydrogen and the carbon monoxide is adjusted by controlling the reverse Boudouard reaction depending on a flow rate of the hydrogen separated in (S2), the carbon monoxide produced in (S3), or the carbon monoxide converted in (S5).

10. The method for manufacturing syngas of claim 8, wherein the molar ratio between the hydrogen and the carbon monoxide is adjusted by supplying separate carbon dioxide to (S3) depending on the flow rate of the hydrogen separated in (S2), the carbon monoxide produced in (S3), or the carbon monoxide converted in (S5).

11. The method for manufacturing syngas of claim 1, wherein the organic wastes in (S1) are at least one selected from waste plastic, solid wastes, biomass, waste oil, or waste tires.

12. An apparatus for manufacturing syngas comprising:
a first reactor where organic wastes are introduced and a gasification reaction is performed under hydrogen;
a hydrogen separation unit where a product is introduced from the first reactor, the hydrogen is separated, and a first mixed gas from which the hydrogen has been removed is recovered;
a second reactor where the first mixed gas from which the hydrogen is removed is introduced from the hydrogen separation unit and a water vapor reforming reaction is performed under a catalyst to form a product;
a carbon dioxide separation unit where the product is introduced from the second reactor, carbon dioxide is separated, and a second mixed gas from which the carbon dioxide has been removed is recovered;
a third reactor where the carbon dioxide separated from the carbon dioxide separation unit is introduced and a reverse Boudouard reaction is performed; and
a syngas production unit where the hydrogen separated from the hydrogen separation unit, the second mixed gas recovered from the carbon dioxide separation unit, and carbon monoxide converted from the third reactor are mixed to produce syngas.

13. The apparatus for manufacturing syngas of claim 12, wherein the first reactor comprises a fluidized bed reactor or a fixed bed reactor.

14. The apparatus for manufacturing syngas of claim 12, wherein the second reactor comprises a fluidized bed reactor.

15. The apparatus for manufacturing syngas of claim 12, wherein the third reactor comprises a fluidized bed reactor.

16. The apparatus for manufacturing syngas of claim 12, wherein the hydrogen separation unit comprises a pressure swing adsorption (PSA) device.

17. The apparatus for manufacturing syngas of claim 12, further comprising:
a cyclone which separates the catalyst from the product of the second reactor;
a supply line which supplies the catalyst separated from the cyclone to the third reactor; and
a recirculation line which resupplies the regenerated catalyst from the third reactor to the second reactor.

18. A method for manufacturing a liquid hydrocarbon, the method comprising:
supplying syngas to a fourth reactor; and
performing a Fischer-Tropsch synthesis reaction in the fourth reactor;
wherein the syngas is the syngas produced by the method of claim 1.

19. The method for manufacturing a liquid hydrocarbon of claim 24, wherein the fourth reactor comprises a fixed bed reactor.

20. The method for manufacturing a liquid hydrocarbon of claim 19, wherein the liquid hydrocarbon comprises naphtha having a boiling point of 150° C. or lower, kerosene having a boiling point of 150 to 265° C., LGO having a boiling point of 265 to 340° C., and VGO having a boiling point of 340° C. or higher.
